(19) United States
(12) Patent Application Publication
(10) Pub. No.: US 2026/0336200 A1
(43) Pub. Date: Oct. 29, 2026

(54) A METHOD OF MANUFACTURING A 3D ITEM BY MEANS OF 3D PRINTING

(71) Applicant: SIGNIFY HOLDING B.V., EINDHOVEN (NL)

(72) Inventors: TIES VAN BOMMEL, HORST (NL); RIFAT ATA MUSTAFA HIKMET, EINDHOVEN (NL)

(21) Appl. No.: 19/116,209

(22) PCT Filed: Oct. 9, 2023
(86) PCT No.: PCT/EP2023/077875

§ 371 Date: Mar. 27, 2025

(30) Foreign Application Priority Data
Oct. 11, 2022 (EP) 22200724.7

(51) Int. Cl. B29C 64/118; B29K 101/12; B29K 105/04; B29L 31/00; B33Y 10/00; B33Y 70/10; B33Y 80/00

(52) U.S. Cl. CPC B29C 64/118; B29K 2101/12; B29K 2105/04; B29K 2995/0001; B29K 2995/0046; B29L 2031/7472; B33Y 10/00; B33Y 70/10; B33Y 80/00

(57) ABSTRACT

The invention provides a method for manufacturing a 3D item (1) by means of 3D printing. The method comprises depositing a 3D printable material (320) to provide the 3D item (1) comprising a stack of layers (330) of 3D printed material. Each layer (330) of the stack of layers (340) of 3D printed material comprises a core (312) and a shell (311). The 3D printable material comprises a core material (212) for forming the core (312) and a shell material (211) for forming the shell (311). The shell material (211) is a thermoplastic polymer having a shell melting temperature and/or a shell glass transition temperature and is deposited from a nozzle (502) having a nozzle temperature, which is higher than the shell melting temperature and/or the shell glass transition temperature. The core material (212) is an acoustically absorbing material (222) so that the core (312) is capable of providing acoustic attenuation. The 3D item (1) produced using the method of this invention is acoustically absorbing.

### FIELD OF THE INVENTION

The invention relates to a method of manufacturing an object by means of 3D printing, in particular by means of fused deposition modelling. The invention also relates to an object obtainable with such a method of manufacturing, and to a lighting device comprising such an object. The invention further relates to a 3D printable material for use in the method of manufacturing.

### BACKGROUND OF THE INVENTION

Digital manufacturing is expected to increasingly transform the nature of global manufacturing. One of the main processes used in digital manufacturing is 3D printing. The term “3D printing” refers to processes wherein a material is joined or solidified under computer control to create a three-dimensional object of almost any shape or geometry. Such three-dimensional objects are typically produced using data from a three-dimensional model, and usually by successively adding material layer by layer.

U.S. Pat. No. 5,121,329 discloses an apparatus incorporating a movable dispensing head provided with a supply of material which solidifies at a predetermined temperature, and a base member, which are moved relative to each other along “X”, “Y”, and “Z” axes in a predetermined pattern to create three-dimensional objects by building up material discharged from the dispensing head onto the base member at a controlled rate. This 3D printing technology is known as fused deposition modeling (FDM).

FDM, also called fused filament fabrication (FFF) or filament 3D printing (FDP), is one of the most commonly used forms of 3D printing. In an FDM process, a 3D printer creates an object in a layer-by-layer manner by extruding a printable material (typically a filament of a thermoplastic material) along tool paths that are generated from a digital representation of the object. The printable material is heated just beyond solidification and extruded through a nozzle of a print head of the 3D printer. The extruded printable material fuses to previously deposited material and solidifies upon a reduction in temperature. In a typical 3D printer, the printable material is deposited as a sequence of planar layers onto a substrate that defines a build plane. The position of the print head relative to the substrate is then incremented along a print axis (perpendicular to the build plane), and the process is repeated until the object is complete.

FDM printers are relatively fast, low cost and can be used for printing complicated three-dimensional objects. Such printers are used in printing various shapes using various 3D printable materials. The technique is also being further developed in the production of LED luminaires and lighting solutions.

WO2022028874 describes a method for 3D printing a 3D item wherein the 3D printable material comprises a shell material and a core material.

For various applications, such as for LED luminaires and lighting solutions, it is desired to have components with acoustically absorbing properties. Materials for providing such acoustically absorbing properties are known in the art and are widely used in, for example, walls and ceilings of buildings to reduce the noise levels.

Although such sound absorbing solutions are widely available, the different form factors that are available are limited and customization is not easily possible. Typically, 3D printing offers the possibility to have many different design choices and to create 3D printed items that are easily customized.

### SUMMARY OF THE INVENTION

It is an object of the present invention to overcome or ameliorate at least one of the disadvantages of the prior art, or to provide a useful alternative.

In a first aspect, the invention provides a method for manufacturing a 3D item by means of 3D printing, wherein the 3D item comprises a stack of layers, each layer comprising a first layer component and a second layer component, the first layer component covering an outer surface of the second layer component, wherein the method comprises the steps of depositing a first material for forming the first layer component and a second material for forming the second layer component. The first material is a thermoplastic polymer having a first melting temperature and/or a first glass transition temperature, wherein the first material is deposited from a nozzle having a nozzle temperature, wherein the nozzle temperature is higher than the first melting temperature and/or the first glass transition temperature. The second material is an acoustically absorbing material.

The outer surface of the second layer component is only partly covered by the first layer component so that the 3D item is capable of absorbing at least a subset of sound incident to the 3D item.

With the method according to the first aspect, a 3D printed item may be manufactured that has sound absorbing properties and solid mechanical integrity. The sound absorbing properties are achieved by the second layer component which is able to provide acoustic attenuation. The second layer component is able to attenuate sounds from the environment of the 3D printed item. In addition to the sound absorbing properties, the 3D printed item has a variety of design possibilities as is inherent in objects produced by a 3D printing process.

The method comprises the step of layer-wise depositing (during a printing stage) a first and a second material, herein also indicated as “3D printable material”, or “materials”. Herein, the term “3D printable material” refers to the material to be deposited or printed, and the terms “first layer component” and “second layer component” refer to the materials that are obtained after deposition, thus the 3D printed material. These materials may be essentially the same, as the 3D printable material may especially refer to the material in a printer head or extruder at elevated temperature and the 3D printed material refers to the same material, but in a later stage when deposited. The 3D printable material is printed as a filament and deposited as such. The 3D printable material may be provided as filament or may be formed into a filament. Hence, whatever starting materials are applied, a filament comprising 3D printable material is provided by the printer head and 3D printed. Herein, the term “3D printable material” may also be indicated as “printable material”. Similarly, the terms “first material” and “second material” refer to the respective materials to be deposited or printed, and the terms “first layer component” and “second layer component” refer to the respective materials that are obtained after deposition.

The printer nozzle may include a single opening. In other examples, the printer nozzle may be of the core-shell type, having two (or more) openings. The term “printer head” may also refer to a plurality of (different) printer heads; hence, the term “printer nozzle” may also refer to a plurality of (different) printer nozzles.

The term “polymer” may refer to a blend of different polymers, but may also refer to essentially a single polymer type with different polymer chain lengths. Hence, the terms “polymer” or “polymeric material” may refer to a single type of polymer but may also refer to a plurality of different polymers. The term “printable material” may refer to a single type of printable material but may also refer to a plurality of different printable materials. The term “printed material” may refer to a single type of printed material but may also refer to a plurality of different printed materials.

Hence, the term “3D printable material” may also refer to a combination of two or more materials. In general, these (polymeric) materials have a glass transition temperature T_{g} and/or a melting temperature Tₘ. The 3D printable material will be heated by the 3D printer before it leaves the nozzle to a temperature of at least the glass transition temperature, and in general at least the melting temperature. Hence, in a specific example the 3D printable material comprises a thermoplastic polymer having a glass transition temperature (Tg) and/or a melting point (Tₘ), and the printer head action comprises heating the 3D printable material above the glass transition and if it is a semi-crystalline polymer above the melting temperature. The 3D printable first material comprises a thermoplastic polymer having a melting point (Tm), and the printer head action comprises heating the 3D printable first material to be deposited on the receiver item to a temperature of at least the melting point. The glass transition temperature is in general not the same thing as the melting temperature. Melting is a transition which occurs in crystalline polymers. Melting happens when the polymer chains fall out of their crystal structures, and become a disordered liquid. The glass transition is a transition which happens to amorphous polymers; that is, polymers whose chains are not arranged in ordered crystals, but are just strewn around in any fashion, even though they are in the solid state. Polymers can be amorphous, essentially having a glass transition temperature and not a melting temperature or can be (semi) crystalline, in general having both a glass transition temperature and a melting temperature, with in general the latter being larger than the former.

As indicated above, the invention thus provides a method comprising providing a filament of 3D printable material and printing (during a printing stage) said 3D printable material on a substrate, to provide said 3D item.

The printable material is printed on a receiver item. Especially, the receiver item can be the printing platform or it can be part of the printing platform. The receiver item can also be heated during 3D printing. However, the receiver item may also be cooled during 3D printing.

Materials that may qualify as first material may comprise thermoplastic materials including one or more of polyacetals (e.g., polyoxyethylene and polyoxymethylene), poly(C₁₋₆ alkyl)acrylates, polyacrylamides, polyamides, (e.g., aliphatic polyamides, polyphthalamides, and polyaramides), polyamideimides, polyanhydrides, polyarylates, polyarylene ethers (e.g., polyphenylene ethers), polyarylene sulfides (e.g., polyphenylene sulfides), polyarylsulfones (e.g., polyphenylene sulfones), poly benzothiazoles, polybenzoxazoles, polycarbonates (including polycarbonate copolymers such as polycarbonate-siloxanes, polycarbonate-esters, and polycarbonate-ester-siloxanes), polyesters (e.g., polycarbonates, polyethylene terephthalates, polyethylene naphtholates, polybutylene terephthalates, polyarylates), and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(C₁₋₆ alkyl)methacrylates, polymethacrylamides, polynorbornenes (including copolymers containing norbornenyl units), polyolefins (e.g., polyethylenes, polypropylenes, polytetrafluoroethylenes, and their copolymers, for example ethylene-alpha-olefin copolymers), polyoxadiazoles, polyoxymethylenes, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, or the like, or a combination comprising at least one of the foregoing thermoplastic polymers. Polyamides may include, but are not limited to, synthetic linear polyamides, e.g., Nylon-6,6; Nylon-6,9; Nylon-6,10; Nylon-6,12; Nylon-11; Nylon-12 and Nylon-4,6, preferably Nylon 6 and Nylon 6,6, or a combination comprising at least one of the foregoing. Polyurethanes that can be used include aliphatic, cycloaliphatic, aromatic, and polycyclic polyurethanes, including those described above.

Also useful are poly(C₁₋₆ alkyl)acrylates and poly(C₁₋₆ alkyl)methacrylates, which include, for instance, polymers of methyl acrylate, ethyl acrylate, acrylamide, methacrylic acid, methyl methacrylate, n-butyl acrylate, and ethyl acrylate, etc. Polyolefine may include one or more of polyethylene, polypropylene, polybutylene, polymethylpentene (and co-polymers thereof), polynorbornene (and co-polymers thereof), poly 1-butene, poly(3-methylbutene), poly(4-methylpentene) and copolymers of ethylene with propylene, 1-butene, 1-hexene, 1-octene, 1-decene, 4-methyl-1-pentene and 1-octadecene.

The second layer componenthas an outer surface that is only partly covered by the first layer component. Having a second layer component which is only partly covered by the first layer compoent increases the ability of the second layer component to absorb acoustic waves. A certain percentage of the outer surface is exposed to the environment and can freely absorb the environmental sounds.

In an example a maximum of 50% of the outersurface may be covered by the first layer component, and/or a minimum of 5% of the outer surface may be covered by the first layer component. With the term “outer surface”, the elongated surface along the length of the second layer component filament is meant. The second layer component may be covered by the first layer component at least to an extent so that the 3D item has sufficient structural integrity, but the second layer component may be covered by the first layer component only to a maximum extent so that the 3D item has the amount of acoustic attenuation needed for its respective purpose.

Materials that may qualify as secondmaterial are generally materials having acoustically absorbing properties. The term “acoustically absorbing” may also be indicated as for example acoustically attenuating, sound absorbing, sound dampening, or noise reducing. Acoustic absorption is the process by which a material takes in sound energy when sound waves are encountered, as opposed to reflecting the energy. A sound absorbing material is thus a material that absorbs sound waves and reduces the amount of sound that is reflected into a space.

The second material and/or the 3D item may have a sound absorption coefficient of at least 0.2, at least 0.4, such as at least 0.5 for sound in a frequency range of 25 Hz to 8000 Hz.

The stack of layers in the 3D item, printed using the second material may have a sound absorption coefficient which is matching its intended use. To that end a sound absorption coefficient may be at least 0.2 but may also be higher if a higher amount of sound absorption is required. The sound absorption coefficient has a range of 0-1 and is the ratio of absorbed sound intensity in a material to the incident sound intensity. It is typically measured in a range of sound frequencies within the range of human hearing and expressed as the maximum absorption value in that range.

The acoustically absorbing materials suitable for use in the method of this invention may comprise foam materials, fibrous materials, porous materials, or a combination of those materials. Materials commonly used for acoustic insulation, such as acoustic foams (made from for example thermosetting polymers, polyurethane, polyether, polyesther, or extruded melamine foam), or fibrous materials (made from for example PET felt, fiberglass, wood, fabric, felt, or (mineral) wool) may possibly be used as second materials. These materials may be effective sound absorbers because they are porous, dense and/or have an acoustic impedance that matches the acoustic impedance of air.

Alternatively or in addition, the acoustically absorbing material may be elastically deformable. During the 3D printing process, the shape of the material may be altered, and it may be deformed (temporarily), but it may always regain its original shape.

The second material may have a second melting temperate and/or a second glass transition temperature, and the nozzle temperature may be lower than the second melting temperature and/or the second glass transition temperature. In addition to earlier examples the second material may now be made from a material which becomes rubbery, viscous, or which melts when heated above the melting temperature and/or glass transition temperature. For the method of this invention this is not desired. Printing this material with a nozzle temperature lower than the second melting temperature and/or lower than the second glass transition temperature ensures that the second material retains (a sufficient amount of) its acoustically absorbing properties when deposited.

The second layer component may have a second diameter Dc and the first layer component may have a first thickness Ts. The second diameter may be at least 1 mm and the first thickness may be less than 0.3 mm. The diameter of the second layer component should be sufficiently large, so that acoustic absorption is achieved. It is further desirable to have a first layer componentwhich is sufficiently thin to allow the second layer component to be acoustically absorbing.

Each of the first material and the second material may be printed continuously. Continuously in the context of this invention means uninterrupted, constant deposition along the longitudinal extension of the filament. The continuously printed filament of second material is deposited together with one or more continuously printed filaments of first material. The first material and the second material maytogether form a core-shell filament, which may be supplied to the 3D printer as one single filament. However, the first material and the second material may also be deposited from multiple separate printer nozzles or printer heads.

The first material and the 3second material, may be provided as two separate materials (for example in the form of filaments) being fed to the 3D printer from different supplying devices. Alternatively, the first and second material may be integrated in a single filament comprising a core comprising the second material and a shell comprising first material, wherein the shell at least partly encloses the core.

The second material may be printed continuously, and the first material may be printed intermittently. The term “intermittently” may also be indicated as printed non-continuous, on and off, periodically, alternating, or interrupted along the longitudinal extension of the filament. The second material is thus printed as an uninterrupted filament whereas the printing of the first material is switched on and off repeatedly at a certain frequency.

In a second aspect, the invention provides a filament. The filament comprises a filament shell comprising a first material, wherein the first material is a thermoplastic polymer, and a filament core comprising a second material, wherein the second material is an acoustically absorbing material and wherein the filament core has an outer surface that is only partly enclosed by the filament shell.

In a third aspect, the invention provides a 3D item comprising a stack of layers. Each layer comprises a first layer component and a second layer component, the first layer component covering an outer surface of the second layer component. The first material is a thermoplastic polymer, and the second material is an acoustically absorbing material, wherein the outer surface is only partly covered by the first layer component so that the 3D item is capable of absorbing at least a subset of sound incident to the 3D item.

The 3D item according to the third aspect further comprising an acoustically absorbing material which may be a foam material, a fibrous material, or a combination of both.

In a specific aspect, the second layer component may have a second diameter Dc and the first layer component may have a first thickness Ts. The second diameter may be at least 1 mm and the first thickness may be less than 0.3 mm. The diameter of the second layer component should be sufficiently large, so that acoustic absorption is achieved. It is further desirable to have a first layer component which is sufficiently thin to allow for the second layer component to be acoustically absorbing.

In yet another example the stack of layers making up the 3D item may be (i) light transmissive and diffusive, and/or (ii) light reflective.

As indicated above, the 3D printed item may be used for different purposes. Amongst others, the 3D printed item may be used in lighting. Hence, in yet a further aspect the invention also provides a lighting device comprising the 3D item as defined herein. In a specific aspect the invention provides a lighting system comprising (a) a light source configured to provide (visible) light source light and (b) the 3D item as defined herein, wherein 3D item may be configured as one or more of (i) at least part of a housing, (ii) at least part of a wall of a lighting chamber, and (iii) a functional component, wherein the functional component may be selected from the group consisting of an optical component, a support, an electrically insulating component, an electrically conductive component, a thermally insulating component, and a thermally conductive component. Hence, in specific examples the 3D item may be configured as one or more of (i) at least part of a lighting device housing, (ii) at least part of a wall of a lighting chamber, and (iii) an optical element. As a relative smooth surface may be provided, the 3D printed item may be used as mirror or lens, etc . . . In examples, the 3D item may be configured as shade. A device or system may comprise a plurality of different 3D printed items, having different functionalities.

Instead of the term “fused deposition modeling (FDM) 3D printer” shortly the terms “3D printer”, “FDM printer” or “printer” may be used. The printer nozzle may also be indicated as “nozzle” or sometimes as “extruder nozzle”.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1c schematically depict some general aspects of the 3D printer and of a 3D printed material;

FIGS. 2a-2b schematically depicts some aspects in relation to e.g. the filament;

FIG. 3 schematically depicts an aspect of the invention;

FIGS. 4a-4c schematically depict some further aspects of the invention;

FIG. 5 schematically depicts an application.

The schematic drawings are not necessarily to scale.

### DETAILED DESCRIPTION OF THE EMBODIMENTS

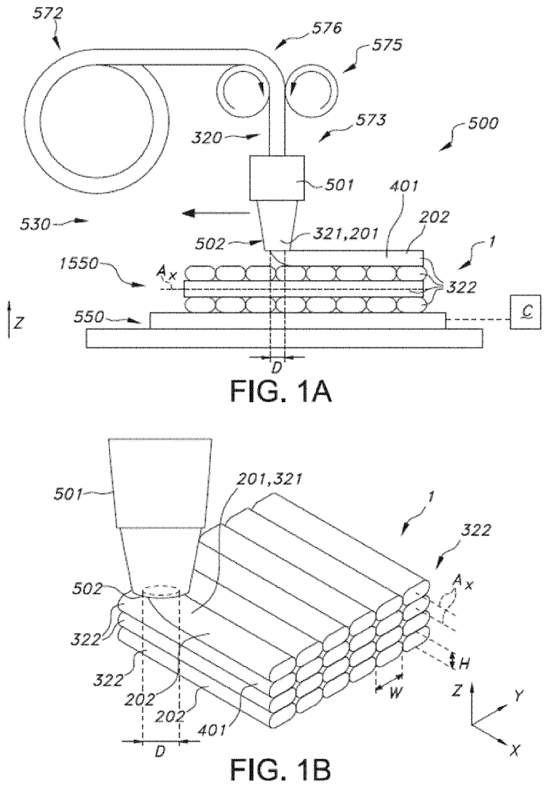

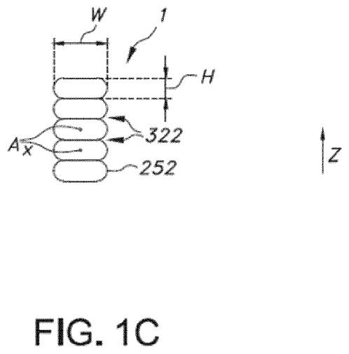

FIG. 1a schematically depicts some aspects of the 3D printer 500. Reference 530 indicates the functional unit configured to 3D print, especially FDM 3D printing; this reference may also indicate the 3D printing stage unit. Here, only the printer head 501 for providing 3D printed material, such as an FDM 3D printer head is schematically depicted.

The 3D printer 500 may include a plurality of printer heads. Reference 502 indicates a printer nozzle. The 3D printer of the present invention may include a plurality of printer nozzles.

Reference 320 indicates a filament of printable 3D printable material 201 (such as indicated above). For the sake of clarity, not all features of the 3D printer have been depicted, only those that are of especial relevance for the present invention (see further also below).

Reference 321 indicates extrudate (of 3D printable material 201).

The 3D printer 500 is configured to generate a 3D item 1 by layer-wise depositing on a receiver item 550, which may at least temporarily be cooled, a plurality of layers 322 wherein each layer 322 comprises 3D printable material 201, such as having a melting point Tₘ. The 3D printable material 201 may be deposited on a substrate 1550 (during the printing stage). By deposition, the 3D printable material 201 has become 3D printed material 202. 3D printable material 201 escaping from the nozzle 502 is also indicated as extrudate 321. Reference 401 indicates thermoplastic material.

The 3D printer 500 may be configured to heat the filament 320 material upstream of the printer nozzle 502. This may e.g. be done with a device comprising one or more of an extrusion and/or heating function. Such device is indicated with reference 573 and is arranged upstream from the printer nozzle 502 (i.e. in time before the filament material leaves the printer nozzle 502). The printer head 501 may (thus) include a liquefier or heater. Reference 201 indicates printable material. When deposited, this material is indicated as (3D) printed material, which is indicated with reference 202.

Reference 572 indicates a spool or roller with material, especially in the form of a wire, which may be indicated as filament 320. The 3D printer 500 transforms this in an extrudate 321 downstream of the printer nozzle 502 which becomes a layer 322 on the receiver item or on already deposited printed material. In general, the diameter of the extrudate 321 downstream of the nozzle 502 is reduced relative to the diameter of the filament 320 upstream of the printer head 501. Hence, the printer nozzle is sometimes (also) indicated as extruder nozzle. Arranging layer 322 by layer 322, a 3D item 1 may be formed. Reference 575 indicates the filament providing device, which here amongst others include the spool or roller and the driver wheels, indicated with reference 576.

Reference A indicates a longitudinal axis or filament axis.

Reference C schematically depicts a control system, such as especially a temperature control system configured to control the temperature of the receiver item 550.

The control system C may include a heater which is able to heat the receiver item 550 to at least a temperature of 50 °C, but especially up to a range of about 350 °C, such as at least 200 °C.

Alternatively or additionally, the receiver plate may also be moveable in one or two directions in the x-y plane (horizontal plane). Further, alternatively or additionally, the receiver plate may also be rotatable about z axis (vertical). Hence, the control system may move the receiver plate in one or more of the x-direction, y-direction, and z-direction.

Alternatively, the printer 500 can have a head 501 that can also rotate during printing. Such a printer has an advantage that the printed material cannot rotate during printing.

Layers are indicated with reference 322, and have a layer height H and a layer width W.

Note that the 3D printable material 201 is not necessarily provided as filament 320 to the printer head. Further, the filament 320 may also be produced in the 3D printer 500 from pieces of 3D printable material.

Reference D indicates the diameter of the nozzle (through which the 3D printable material 201 is forced).

FIG. 1b schematically depicts in 3D in more detail the printing of the 3D item 1 under construction. Here, in this schematic drawing the ends of the filaments 321 in a single plane are not interconnected, though in reality this may be the case. Reference H indicates the height of a layer. Layers are indicated with reference 322. Here, the layers have an essentially circular cross-section. Often, however, they may be flattened, such as having an outer shape resembling a flat oval tube or flat oval duct (i.e. a circular shaped bar having a diameter that is compressed to have a smaller height than width, wherein the sides (defining the width) are (still) rounded).

Hence, FIGS. 1a-1b schematically depict some aspects of a fused deposition modeling 3D printer 500, comprising (a) a first printer head 501 comprising a printer nozzle 502, (b) a filament providing device 575 configured to provide a filament 321 comprising 3D printable material 201 to the first printer head 501, and optionally (c) a receiver item 550. In FIGS. 1a-1b, the first or second printable material or the first or second printed material are indicated with the general indications printable material 201 and printed material 202, respectively. Directly downstream of the nozzle 502, the filament 321 with 3D printable material becomes, when deposited, layer 322 with 3D printed material 202.

FIG. 1c schematically depicts a stack of 3D printed layers 322, each having a layer height H and a layer width W. Note that in specific examples the layer width and/or layer height may differ for two or more layers 322. Reference 252 in FIG. 1c indicates the item surface of the 3D item (schematically depicted in FIG. 1c).

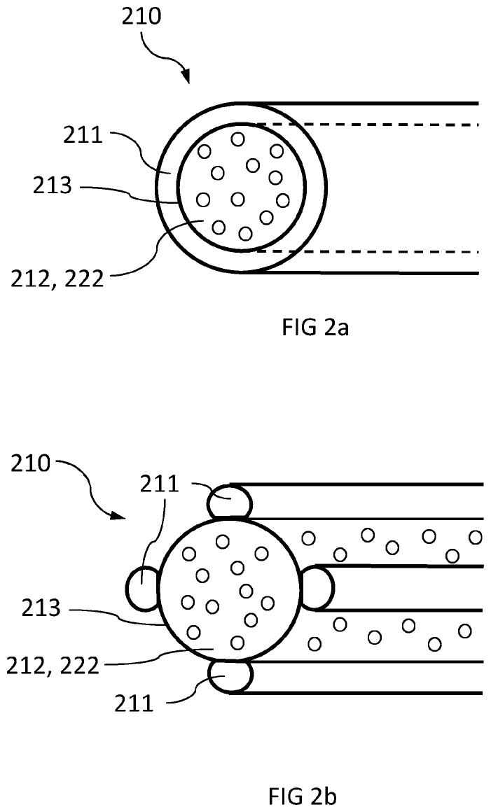

Referring to FIGS. 1a-1c, the filament of 3D printable material 321 that is deposited leads to a layer having a height H (and width W). Depositing layer 322 after layer 322, the 3D item 1 is generated. FIG. 1c very schematically depicts a single-walled 3D item 1. FIGS. 2a-2b depict examples of core-shell filaments 210 that may be used in the method of this invention. The core-shell filament 210 comprises first material as shell material 211 and second material as core material 212.

The first material or shell material 211 is a thermoplastic polymer. The shell material 211 becomes, when deposited, the first layer component 311 of the 3D printed material. The shell material 211 is deposited through a heated nozzle 502. The nozzle temperature is higher than the melting temperature and/or the glass transition temperature of the shell material 211. The thermoplastic polymer used as shell material in this method may have a high viscosity to limit penetration into the second layer component 312 during the method.

FIG. 2a schematically depicts an example where the shell material 211 completely encloses the core material 212. FIG. 2b schematically depicts an example where the first material or in other words shell material 211 partly encloses the core material 212.

The second material or in other words core material 212 comprises an acoustically absorbing material 222. The core material 212 becomes, when deposited, the second layer component 312 of the 3D printed material 202. The second layer component 312 is capable of providing acoustic attenuation, or in other words is sound absorbing, sound dampening, or noise reducing. The acoustically absorbing material 222 may be a foam material and/or a fibrous material but can also be any other material with sound absorbing properties which is suitable for producing in a filament like shape and/or which can be processed by a 3D printer. Different types of foam materials may be especially suitable for use in this invention, such as for example an open-celled foam or a closed-celled foam. The second material may also be elastically deformable.

Typical materials used to produce acoustically absorbing foam materials, also referred to as acoustic foams, are thermosetting polymers, such as polyurethane. These polymers do not have a melting temperature due to their cross-linked structure. Materials without melting temperatures naturally cannot melt during the 3D printing process and are especially suitable as second material 212 to be used in this invention. A second material 212 comprising a material not having a melting temperature may be processed by the 3D printer 500 and may be fed through the nozzle 502 to be deposited with basically no or little change to its structure, its morphology, or its acoustically absorbing properties. Even though these materials cannot melt, they can burn and char when heated to high temperatures. This needs to be taken account in the 3D printing method and the nozzle temperature needs to stay below the temperature at which the second material 211 starts to char, burn, or degrade in any other way. This would also negatively influence the acoustically absorbing properties as well as the structural integrity and aesthetics of the 3D item 1 and should be avoided. Thermosetting polymers are named here as one example of a material without melting temperature, but one can think of many more alternatives of such acoustically absorbing materials which may all be suitable for the use in this invention.

Alternatively, the second material 212 may also comprise a material having a melting temperature and/or a glass transition temperature. In the case that such a material is used as second material 212, the nozzle 502 of the 3D printer 500 preferably has a nozzle temperature which is lower than the melting temperature and/or lower than the glass transition temperature of the second material 212. This ensures that the second material 212 does not melt or change its structure or morphology irreversibly during the 3D printing process and therefore retains enough of its acoustically absorbing properties.

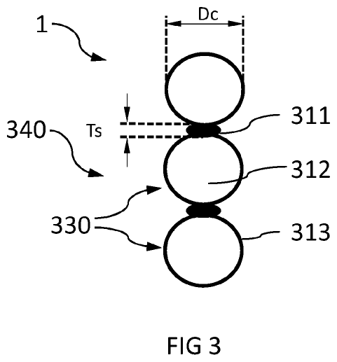

FIG. 3 schematically depicts a stack 340 of 3D printed layers 330. Each layer 330 of the stack of layers 340 of 3D printed material comprises a second layer component 312 and a first layer component 311. In the finished 3D item 1 a stack of layers 340 may take different shapes and sizes. The stack of layers 340 may have at least 10 layers, at least 50 layers, or at least 100 layers. For an improved noise reduction and/or to create sufficient thickness, multiple layers may also be printed next to each other, not only on top of each other.

The geometry, especially the diameter of the second layer component Dc, and the thickness of the first layer component Ts in the filaments are indicated in FIG. 3. The second diameter needs to be large enough to provide sufficient acoustic attenuation. The thickness of the first layer component 311 is rather thin to minimize the acoustic reflection of the first layer component 311 and to maximize the acoustic attenuation of the second layer component 312. The first thickness Ts may be at most 0.3 mm, at most 0.2 mm, at most 0.1 mm such as for example 0.08 mm. In order to provide a proper first layer component, a minimum thickness of the first layer component may be required which may be at least 0.03 mm. A small first thickness Ts is also preferred in examples in which the first layer component 311 partly encloses the outer surface 313 of the second layer component 312. A small Ts may allow the second layer component 312 to be exposed to the surroundings and to limit openings between neighboring layers. In many possible applications of the 3D item 1 openings between adjacent layers may not be desired since they allow acoustic waves to pass through unattenuated. The second layer component 312 needs to provide sufficient noise reduction and may therefore be at least 1 mm in diameter. But the second layer component 311 may also be at least 0.5 mm, 2 mm, 3 mm, or 5 mm in diameter, depending on the second material used and the specific application of the 3D printed item 1.

The second layer component 312 has an outer surface 313 which is partly enclosed by the first layer component 311. The second layer component 312 is capable of providing increased acoustic attenuation in surface areas that are not enclosed by the first layer component 311.

Therefore, only a certain percentage of the outer surface 313 may be covered by the first layer component. This percentage may be a maximum of 50%, but may also be a maximum of 60%, 70%, or 80%. In essence, the second layer component may be covered to such an extent that the 3D item 1 produced using this method has at least an amount of sound absorption needed for its specific use. Typical sound absorption coefficients achieved may be at least 0.2, at least 0.4, such as at least 0.5 for sound in a frequency range of 25 Hz to 8000 Hz.

On the other hand, the outer surface 313 enclosed by the first layer component 311 needs to be large enough to provide mechanical integrity of the 3D item 1 produced with this method. The adhesion between layers is largely determined by the amount and position of the first layer component 311. The connection between each of the layers 330 of the stack of layers 340 needs to be sufficient for the specific use of the 3D item 1 produced with this method. The first layer component 311 may cover at least 5% of the outer surface 313 to achieve the desired mechanical integrity. But in other examples the second layer component 312 may be enclosed by the first layer component 311 for at least 1%, 2%, or 10%.

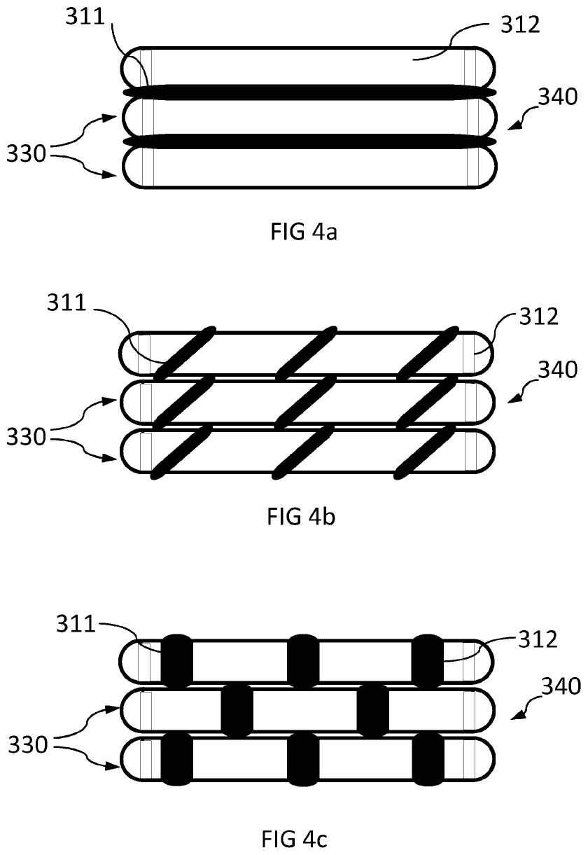

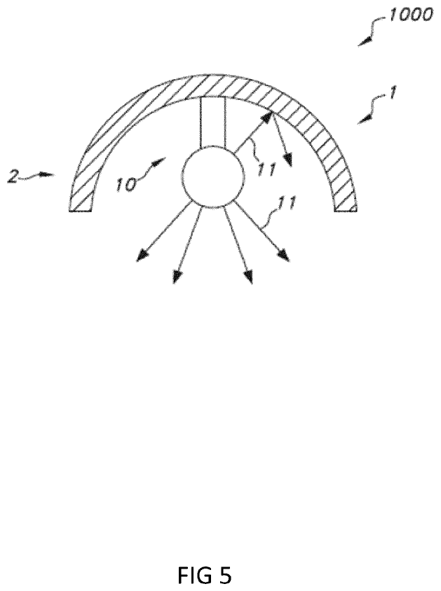

FIGS. 4a-4c show different example configurations of the first layer component and the second layer component which are depicted in a simplified representation of a stack of layers 340. More than one first layer component 311 may be used for improved adhesion between second layer components 312. As shown in FIG. 4a the first layer component 311 may be applied between two neighboring second layer components 312 to improve adhesion between neighboring layers 330. FIG. 4b shows an example where the one or more first layer componentns 311 may be rotated (or wrapped) around the second layer component 312. Both, the first material 211 and the second material 212 may be deposited continuously. That means that one uninterrupted filament of second material 212 is deposited together with one or more uninterrupted filaments of first material 211 to create a layer of deposited second layer component 312 and first layer component 311. The first material 211 and the second material 212 may together form a single core-shell filament 210 which is printed from a single nozzle. However, the second material 212 and the first material 211, may also be provided as two separate materials (for example in the form of filaments) being fed to the 3D printer 500 from different supplying devices. Those materials can then subsequently be deposited from a single print head 501 or printer nozzle 502, or from multiple print heads or multiple printer nozzles.

FIG. 4c schematically depicts an example of an implementation where the first material 211 may be deposited intermittently together with a continuously deposited second material 212. The second material 212 is thus printed as an uninterrupted filament whereas the printing of the first material 211 is switched on and off repeatedly at a certain frequency. This frequency may be constant but may also vary for example per layer. In such an example the first layer component 311 may completely enclose the diameter of the second layer component 312 for the periods that the deposition of the first material 211 is switched on. In periods where no first material 211 is printed the second layer component 312 is not enclosed by the first layer component 311 at all.

The first layer component 311 and/or the second layer component 312 may be light transmissive, diffusive and/or light reflective. The light reflectivity may be at least 80%, may be at least 85%, or may be at least 88%. The light transmission may be in a range from 20 to 80%, may be in a range from 30 to 70%, or may be in a from 35 to 65%. The absorption may be equal or less than 10%, may be lower than 5%, or may be lower than 3%. A transparent or light transmissive 3D printing material may for example be achieved by using a material such as polycarbonate. A light reflective 3D printing material may for example be achieved by adding reflective particles, such as light scattering particles (e.g. TiO2, BaSO4 and Al2O3) or reflective flakes (e.g. comprising aluminum or silver). The first layer component 311 and/or the second layer component 312 may be colored. Both may have the same color or the second layer component 312 and the first layer component 311 may also have different colors.

FIG. 5 schematically depicts an example of a lamp or luminaire 2, which comprises a light source 10 for generating light 11. The lamp 2 may comprise a housing or shade or another element, which may comprise or be the 3D printed item 1. Here, the half sphere (in cross-sectional view) schematically indicates a housing or shade. The lamp or luminaire 2 may be or may comprise a lighting device 1000 (which comprises the light source 10). Hence, the lighting device 1000 comprises the 3D item 1. The 3D item 1 may be configured as one or more of (i) at least part of a lighting device housing, (ii) at least part of a wall of a lighting chamber, and (iii) an optical element. Hence, the 3D item 1 may be reflective for light source light 11 and/or transmissive for light source light 11. Here, the 3D item 1 may e.g. be a housing or shade.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The various aspects discussed in this patent can be combined in order to provide additional advantages. Further, the person skilled in the art will understand that embodiments can be combined, and that also more than two embodiments can be combined.

1. A method for manufacturing a 3D item by means of 3D printing, wherein the 3D item comprises a stack of layers, each layer comprising a first layer component and a second layer component, the first layer component covering an outer surface of the second layer component,
wherein the method comprises depositing a first material for forming the first layer component and a second material for forming the second layer component
wherein the first material is a thermoplastic polymer having a first melting temperature and/or a first glass transition temperature;
wherein the first material is deposited from a nozzle having a nozzle temperature;
wherein the nozzle temperature is higher than the first melting temperature and/or the shell glass transition temperature;
wherein the second material is an acoustically absorbing material
wherein the outer surface is only partly covered by the first layer component so that the 3D item is capable of absorbing at least a subset of sound incident to the 3D item.

2. The method according claim 1, wherein a maximum of 50% of the outer surface is covered by the first layer component, and/or wherein a minimum of 5% of the outer surface is covered by the first layer component.

3. The method according to claim 1, wherein the second material and/or the 3D item has a sound absorption coefficient of at least 0.2 for sound in a frequency range of 25 Hz to 8000 Hz.

4. The method according to claim 1, wherein the acoustically absorbing material comprises a foam material and/or a fibrous material.

5. The method according to claim 1, wherein the acoustically absorbing material is elastically deformable.

6. The method according to claim 1, wherein the second material has a second melting temperature and/or a second glass transition temperature, and wherein the nozzle temperature is lower than the second melting temperature and/or the second glass transition temperature.

7. The method according to claim 1, wherein the second layer component has a second diameter Dc and the first layer component has a first thickness Ts, wherein Dc≥1 mm and Ts≤0.3 mm.

8. The method according to claim 1, wherein each of the second material and the first material is printed continuously.

9. The method according to claim 1, wherein the second material is printed continuously and wherein the first material is printed intermittently.

10. A filament for use in the method according to claim 1 comprising a filament shell comprising a first material, wherein the first material is a thermoplastic polymer, and
a filament core comprising a second material, wherein the second material is an acoustically absorbing material and wherein the filament core has an outer surface that is only partly enclosed by the filament shell.

11. A 3D item comprising a stack of layers,
wherein each layer comprises a first layer component and a second layer component, the first layer component covering an outer surface of the second layer component,
wherein the first material is a thermoplastic polymer,
wherein the second material is an acoustically absorbing material,
wherein the outer surface is only partly covered by the first layer component so that the 3D item is capable of absorbing at least a subset of sound incident to the 3D item.

12. The 3D item according to claim 11, wherein the acoustically absorbing material comprises a foam material and/or a fibrous material.

13. The 3D item according to claim 11, wherein the second layer component has a second diameter Dc and the first layer component has a first thickness Ts, wherein Dc≥1 mm and Ts≤0.3 mm.

14. The 3D item according to claim 11, wherein the stack of layers is (i) light transmissive and diffusive, and/or (ii) light reflective.

15. A lighting device comprising a light source and the 3D item according to claim 11, wherein the 3D item is configured as one or more of (i) at least part of a lighting device housing, (ii) at least part of a wall of a lighting chamber, and (iii) an optical element.
